(19) United States
(12) Patent Application Publication
(10) Pub. No.: US 2012/0042783 A1
(43) Pub. Date: Feb. 23, 2012

(54) AERATION APPARATUS, SEAWATER FLUE GAS DESULPHURIZATION APPARATUS INCLUDING THE SAME, AND METHOD FOR OPERATING AERATION APPARATUS

(76) Inventors: Keisuke SONODA, Minato-ku (JP); Shozo Nagao, Minato-ku (JP); Koji Imasaka, Minato-ku (JP); Seiji Furukawa, Minato-ku (JP); Yoshihiko Tsuchiyama, Minato-ku (JP)

(21) Appl. No.: 13/152,359

(22) Filed: Jun. 3, 2011

Related U.S. Application Data
(60) Provisional application No. 61/419,398, filed on Dec. 3, 2010.

(30) Foreign Application Priority Data
Aug. 18, 2010 (JP) 2010-183498

(51) Int. Cl. B01D 53/96; B01F 3/04; C02F 1/74

(52) U.S. Cl. 96/235; 261/121.1; 210/758

(57) ABSTRACT

An aeration apparatus is immersed in diluted used seawater (not shown) which is water to be treated and generates fine air bubbles in the diluted used seawater. The aeration apparatus includes: an air supply line L₅ for supplying air 122 through blowers 121A to 121D serving as discharge unit; aeration nozzles 123, each of which includes a diffuser membrane 11 having slits and to which air containing moisture is supplied; and a control unit for performing control to temporarily stop supply of the air 122 at predetermined intervals.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (aeration) of wastewater (used seawater) from a flue gas desulphurization apparatus for desulphurization using a seawater method. The invention also relates to a seawater flue gas desulphurization apparatus including the aeration apparatus and to a method for operating the aeration apparatus.

### BACKGROUND

In conventional power plants that use coal, crude oil, and the like as fuel, combustion flue gas (hereinafter referred to as “flue gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### CITATION LIST

### Patent Literature

Patent Literature 1: Japanese Patent Application Laid-open No. 2006-055779

Patent Literature 2: Japanese Patent Application Laid-open No. 2009-028570

Patent Literature 3: Japanese Patent Application Laid-open No. 2009-028572

### SUMMARY

### Technical Problem

Aeration nozzles used in the aeration apparatus each have a large number of small slits formed in a rubber-made diffuser membrane that covers a base. Such aeration nozzles are generally referred to as “diffuser nozzles”. These aeration nozzles can eject many fine air bubbles of substantially equal size from the slits with the aid of the pressure of the air supplied to the nozzles.

When aeration is continuously performed in seawater using the above aeration nozzles, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can remove precipitates generated in the slits of diffuser membranes, a seawater flue gas desulphurization apparatus including the aeration apparatus, and a method for operating the aeration apparatus. Solution to Problem

According to an aspect of the present invention, an aeration apparatus that is immersed in water to be treated and generates fine air bubbles in the water to be treated includes: an air supply pipe for supplying air through discharge unit; an aeration nozzle including a diffuser membrane having a slit, the air being supplied to the aeration nozzle; and a control unit for performing control to temporarily stop supply of the air at predetermined intervals.

According to another aspect of the present invention, an aeration apparatus that is immersed in water to be treated and generates fine air bubbles in the water to be treated includes: an air supply pipe for supplying air through discharge unit; an aeration nozzle including a diffuser membrane having a slit, the air being supplied to the aeration nozzle; and a control unit for performing control to temporarily increase supply of the air at predetermined intervals.

Advantageously, in the aeration apparatus, the control unit performs control to temporarily increase the supply of the air and simultaneously feed water to the air supply pipe.

Advantageously, in the aeration apparatus, the control unit performs control to temporarily stop the supply of the air and simultaneously feed water to the air supply pipe.

Advantageously, in the aeration apparatus, the aeration nozzle further includes: a cylindrical base support body into which the air is introduced; a hollow cylindrical body that has a diameter smaller than a diameter of the base support body and that is disposed at an axial position of the base support body via a partition plate; an end support body that is disposed at one end of the hollow cylindrical body and that has approximately the same diameter as the diameter of the base support body; a tubular diffuser membrane that covers the base support body and the end support body and of which both ends are fastened to the base support body and the end support body, respectively; a large number of the slits formed in the tubular diffuser membrane; and an air outlet hole formed in the side surface of the base support body for allowing introduced air to flow into a pressurization space between an inner circumferential surface of the diffuser membrane and outer circumferential surfaces of the support bodies in front of the partition plate.

Advantageously, in the aeration apparatus, the aeration nozzle further includes: a cylindrical base support body into which the air is introduced; an end support body that has approximately the same diameter as the base support body; a tubular diffuser membrane that covers the base support body and the end support body and of which both ends are fastened to the base support body and the end support body, respectively; and a large number of the slits formed in the tubular diffuser membrane.

According to still another aspect of the present invention, a seawater flue gas desulphurization apparatus includes: a desulfurizer that uses seawater as an absorbent; a water passage for allowing used seawater discharged from the desulfurizer to flow therethrough and be discharged; and the aeration apparatus described above that is disposed in the water passage, the aeration apparatus generating fine air bubbles in the used seawater to decarbonate the used seawater.

According to still another aspect of the present invention, a method for operating an aeration apparatus, includes: using an aeration apparatus that is immersed in water to be treated and used to generate fine air bubbles in the water to be treated; and temporarily stopping or increasing supply of air at predetermined intervals when supplying air through discharge unit, thereby preventing clogging.

Advantageously, the method further includes: feeding water to an air supply pipe, the feeding being performed independently or at the same time when temporarily stopping or increasing the supply of air.

### Advantageous Effects of Invention

According to the present invention, it is possible to remove precipitates generated in the slits of the diffuser membranes of the aeration apparatus.

### BRIEF DESCRIPTION OF DRAWINGS

FIG. 1 is a schematic diagram of a seawater flue gas desulphurization apparatus according to an embodiment.

FIG. 2A is a plan view of aeration nozzles.

FIG. 2B is a front view of the aeration nozzles.

FIG. 3 is a schematic diagram of the inner structure of an aeration nozzle.

FIG. 4 is a schematic diagram of an aeration apparatus according to an embodiment.

FIG. 5 is a schematic diagram of another aeration apparatus according to the embodiment.

FIG. 6 is a graph showing a change in pressure loss of a diffuser membrane over time when supply of air is temporarily stopped.

FIG. 7 is a graph showing a change in pressure loss of the diffuser membrane over time when supply of air is temporarily increased.

FIG. 8 is a schematic diagram of the inner structure of an aeration nozzle according to the embodiment.

FIG. 9 is a schematic diagram of the inner structure of another aeration nozzle according to the embodiment.

FIG. 10 is a schematic diagram of a disk-type aeration nozzle according to the embodiment.

FIG. 11A is a diagram illustrating the states of the outflow of air (humid air at low saturation), the inflow of seawater, and concentrated seawater in a slit of a diffuser membrane.

FIG. 11B is a diagram illustrating the states of the outflow of air, the inflow of seawater, and concentrated seawater in the slit of the diffuser membrane.

FIG. 11C is a diagram illustrating the states of the outflow of air, the inflow of seawater, concentrated seawater, and precipitates in the slit of the diffuser membrane.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### Embodiments

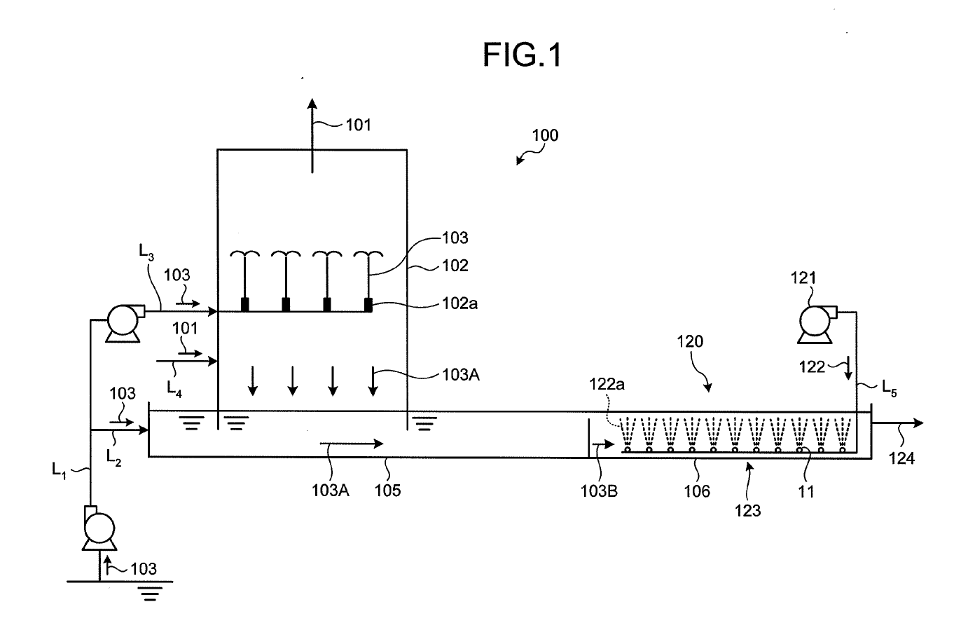

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

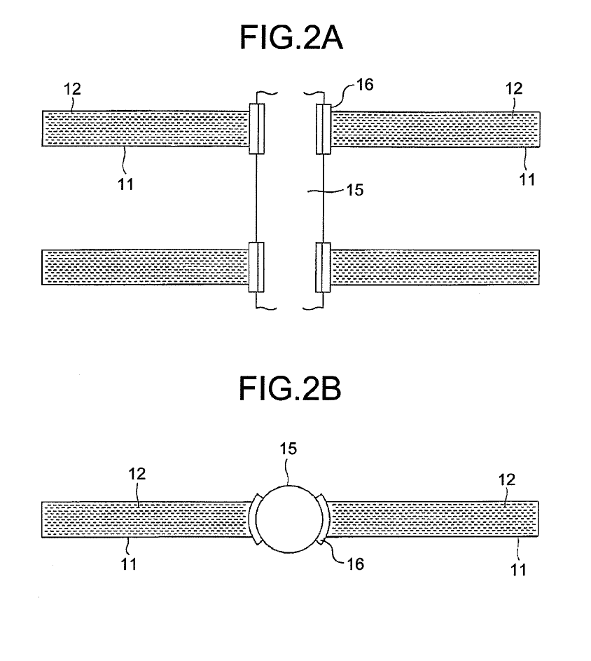

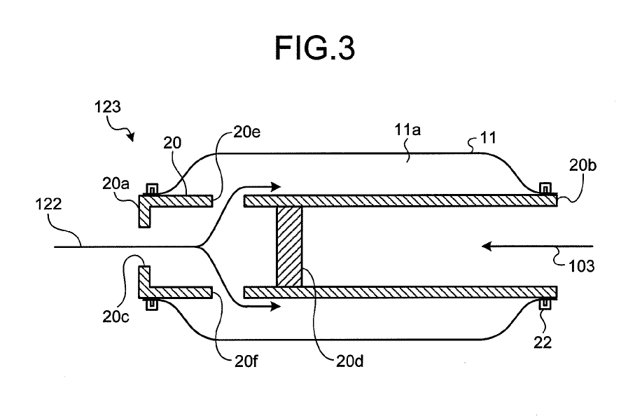

The structure of the aeration nozzles 123 is described with reference to FIGS. 2A, 2B, and 3.

FIG. 2A is a plan view of the aeration nozzles; FIG. 2B is a front view of the aeration nozzles; and FIG. 3 is a schematic diagram of the inner structure of an aeration nozzle.

As shown in FIGS. 2A and 2B, each aeration nozzle 123 has a large number of small slits 12 formed in a rubber-made diffuser membrane 11 that covers the circumference of a base and is generally referred to as a “diffuser nozzle.” In such an aeration nozzle 123, when the diffuser membrane 11 is expanded by the pressure of the air 122 supplied from the air supply line L₅, the slits 12 open to allow a large number of fine air bubbles of substantially equal size to be ejected.

As shown in FIGS. 2A and 2B, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

For example, as shown in FIG. 3, each aeration nozzle 123 is formed as follows. A substantially cylindrical support body 20 that is made of a resin in consideration of corrosion resistance to the diluted used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, the air 122 is continuously supplied, so that the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

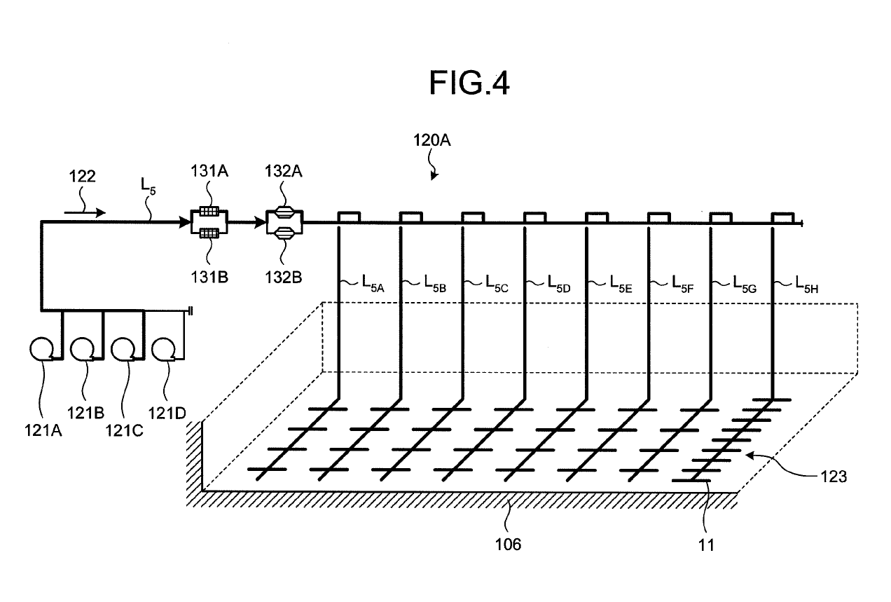

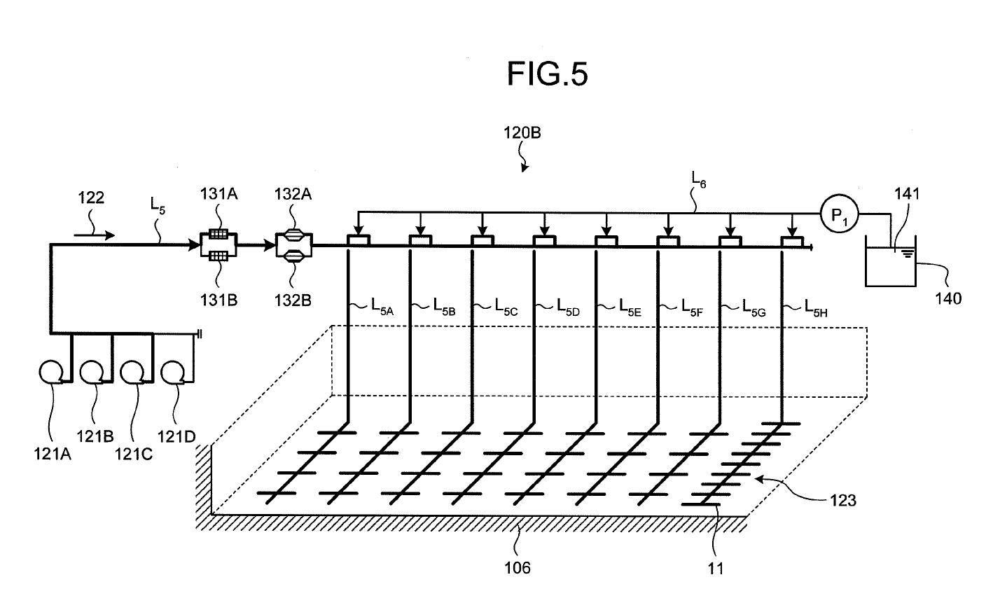

In the aeration nozzle 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration nozzles 123 to which air is supplied through branch pipes L_{5A} to L_{5H} and the headers 15 (see FIGS. 4 and 5).

Aeration apparatuses according to an embodiment will next be described. The present invention provides means for removing precipitates deposited in the slits 12 by causing change in the pressure of the air 122 supplied to the diffuser membrane 11.

FIG. 4 and FIG. 5 are schematic diagrams of the aeration apparatus according to the present embodiment.

As shown in FIG. 4, an aeration apparatus 120A according to the present embodiment is immersed in diluted used seawater (not shown), which is water to be treated, and generates fine air bubbles in the diluted used seawater. This aeration apparatus includes: an air supply line L₅ for supplying air 122 through blowers 121A to 121D serving as discharge unit; aeration nozzles 123, each of which includes a diffuser membrane 11 having slits and to which air containing moisture is supplied; and a control unit (not shown) for performing control to temporarily stop supply of the air 122 at predetermined time intervals. Two cooling units 131A and 131B and two filters 132A and 132B are provided in the air supply line L₅. The air compressed by the blowers 121A to 121D is thereby cooled and then filtrated.

Normally, three of the four blowers are used for operation, and one of them is a reserve blower. Since the aeration apparatus must be continuously operated, only one of the two cooling units 131A and 131B and only one of the two filters 132A and 132B are normally used, and the others are used for maintenance.

In the present embodiment, the salt concentration in seawater is generally 3.4%, and 3.4% of salts are dissolved in 96.6% of water. The salts include 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the deposition threshold value of the salt concentration in seawater is about 14%.

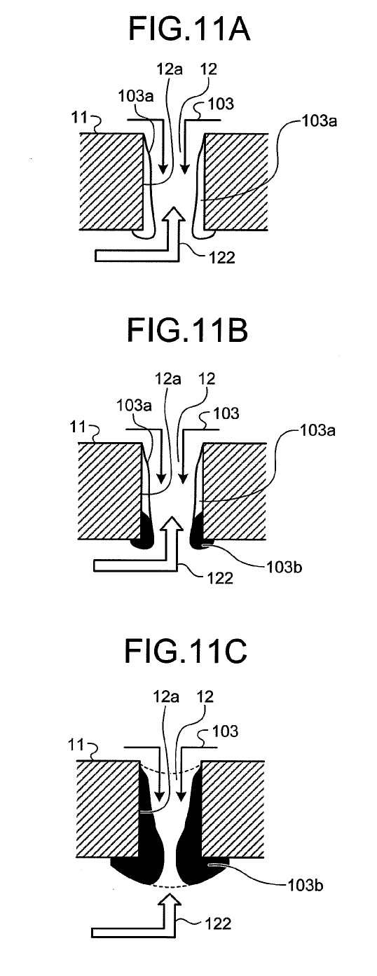

A mechanism of deposition of precipitates in the slits 12 will be described with reference to FIG. 11A to FIG. 11C.

FIG. 11A is a diagram illustrating the states of the outflow of air (humid air at low saturation), the inflow of seawater, and concentrated seawater in a slit of a diffuser membrane. FIG. 11B is a diagram illustrating the states of the outflow of air, the inflow of seawater, and concentrated seawater in the slit of the diffuser membrane. FIG. 11C is a diagram illustrating the states of the outflow of air, the inflow of seawater, concentrated seawater, and precipitates in the slit of the diffuser membrane.

In the present invention, the slits 12 are cuts formed in the diffuser membranes 11, and the gap of each slit 12 serves as a discharge passage of air.

The seawater 103 is in contact with slit wall surfaces 12a that form the passage. The introduction of the air 122 causes the seawater to be dried and concentrated to form concentrated seawater 103a. Then a precipitate 103b is deposited on the slit wall surfaces and clogs the passage in the slits.

In the state shown in FIG. 11A, seawater is dried and concentration of the seawater gradually proceeds because relative humidity of the air 122 is low, so that the concentrated seawater 103a is formed. However, even after the concentration of the seawater is started, if the salt concentration in the seawater is equal to or lower than 14%, calcium sulfate or the like is not deposited.

In the state shown in FIG. 11B, the precipitate 103b is generated in portions of the concentrated seawater 103a in which the salt concentration in the seawater locally exceeds approximately 14%. In this state, the amount of the precipitate 103b is very small. Therefore, although the pressure loss when the air passes through the slit 12 increases slightly, the air 122 can pass through the slit 12.

In this state, by changing the pressure as will be described below, precipitates are forcibly removed and operation can be performed for a long time.

However, in the state shown in FIG. 11C, since the concentration of the concentrated seawater 103a has proceeded further, a clogged (plugged) state due to the precipitate 103b is formed, and the pressure loss is high. Even in this state, the passage of the air 122 remains present, but the load on the discharge unit is considerably large. Therefore, the pressure is changed as will be described below so that the precipitates can be removed before the above situation occurs.

Even in this state, it is possible to forcibly remove precipitates by changing the pressure as will be described below.

In the present embodiment, the control unit issues a command to temporarily stop supply of the air 122 at predetermined time intervals in order to avoid the above clogged state.

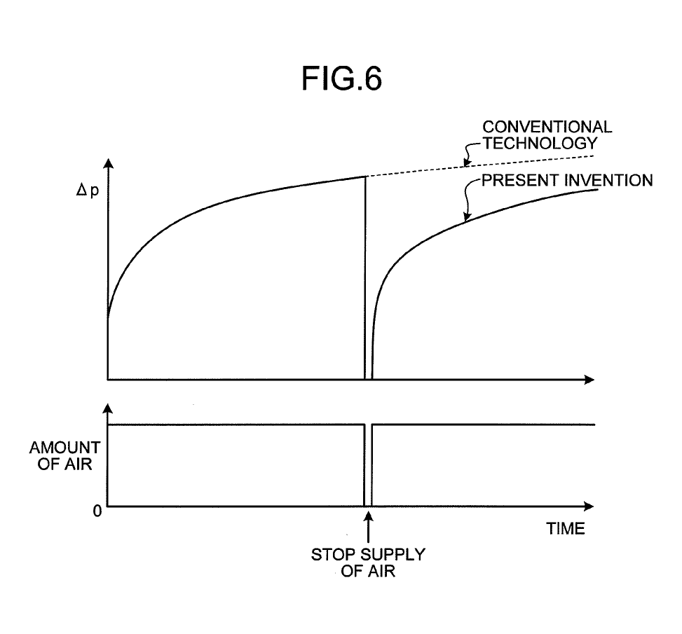

FIG. 6 is a graph showing a change in pressure loss of the diffuser membrane over time when supply of air is temporarily stopped.

As shown in FIG. 6, the supply of the air 122 is temporarily stopped at predetermined time intervals, so that the pressure changes (the pressure temporarily becomes 0). Accordingly, the expanded diffuser membrane 11 is contracted and precipitates such as calcium sulfate deposited on the slit 12 come off, so that the slit 12 returns to normal.

Therefore, it is possible to prevent clogging of the slits 12 and narrowing of the gaps of the slits 12, which are caused by deposition of calcium sulfate through continuous operation. As a result, it is possible to prevent pressure loss of the diffuser membranes 11.

The interval to stop the supply of the air 122 may be appropriately changed according to the deposition states of precipitates. Preferably, the supply of air is stopped once a day or once every two days.

By stopping the supply of air in order to change the pressure of the air passing through the slits 12 at the early stage of the deposition, it is possible to cause precipitates to come off easily.

The supply of the air 122 may be stopped by stopping the blowers 121A to 121D serving as discharge unit. A switching valve (not shown) may be disposed in the air supply line L₅ to stop the supply of the air 122 toward the aeration nozzles 123 side. The air 122 of which flow has been switched, which is compressed air, is stopped or relieved by a damper means or a relief valve.

As shown in FIG. 5, an aeration apparatus 120B according to the present embodiment includes a water supply line L₆ for supplying fresh water 141 from a fresh-water tank 140 to the air supply line L₅. In this case, precipitates are purged due to water pressure. The control unit (not shown) may perform the control to supply the fresh water 141 to the air supply line L₅ at the same time with the control to temporarily stop the supply of the air 122.

As described above, the fresh water 141 is supplied and thereby introduced into the aeration nozzles 123. Accordingly, the slits 12 of the diffuser membranes 11 are cleaned, so that precipitates such as calcium sulfate adhered to the slits 12 can be dissolved and removed.

As a result, it is possible to prevent clogging of the slits 12 or narrowing of the gaps of the slits 12, which are caused by the deposition of calcium sulfate, making it possible to prevent pressure loss of the diffuser membranes 11.

The cleaning is appropriately performed when the pressure loss of the slits is not recovered by stopping the supply of air.

It is possible to supply water at the same time when air is being introduced.

In the present embodiment, the fresh water 141 is used as water to be supplied. However, instead of the fresh water, seawater (such as seawater 103 from the dilution seawater supply line L₂, used seawater 103A in the dilution-mixing basin 105, or the diluted used seawater 103B in the oxidation basin 106) or water vapor may be used. When water vapor is used, water vapor is liquidized by a cold condensation means (not shown).

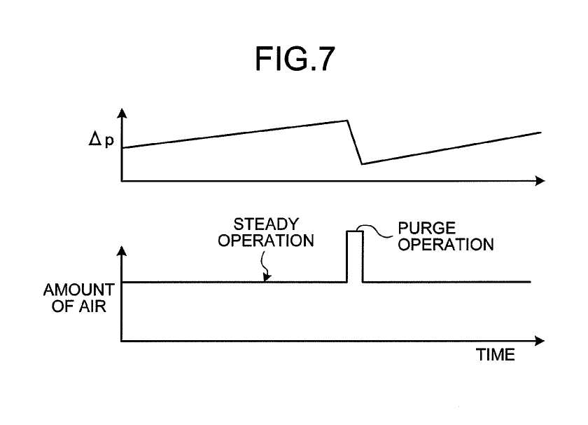

FIG. 7 is a graph showing a change in pressure loss of the diffuser membrane over time when supply of air is temporarily increased. As shown in FIG. 7, purge operation for increasing the amount of air is performed for a predetermined time after a lapse of a predetermined time during steady operation.

The supply of the air 122 is increased at predetermined time intervals as above, so that the pressure changes (the amount of air temporarily increases) and the speed of air passing through the slits increases. Therefore, precipitates of calcium sulfate deposited in the slits 12 are discharged to the outside, and the slits 12 returns to normal.

As a result, it is possible to prevent clogging of the slits 12 and narrowing of the slits 12, which are caused by deposition of calcium sulfate through continuous operation. Consequently, it is possible to prevent pressure loss of the diffuser membranes 11.

The interval of increase may be appropriately changed according to the deposition states of precipitates. Preferably, the supply is increased once a day or once every two days.

By temporarily increasing the supply of air in order to change the pressure of the air passing through the slits 12 at the early stage of the deposition, it is possible to easily discharge precipitates to the outside.

For temporarily increasing the supply of air, when, for example, three blowers 121A to 121C are normally operated in the aeration apparatus 120A shown in FIG. 4, an increased amount of the air 122 can be supplied to the air supply line L₅ by additionally driving the reserve blower 121D.

That is, by operating the blowers 121A to 121D, the amount of the air 122 introduced into the aeration nozzles 123 temporarily increases. Therefore, the speed of air passing through the slits increases and calcium sulfate can be removed to the seawater side.

Consequently, it is possible to prevent clogging of the slits 12 and narrowing of the gaps of the slits 12, which are caused by deposition of calcium sulfate. As a result, it is possible to prevent pressure loss of the diffuser membranes 11.

When the capacity of the blower is insufficient, a predetermined purge condition may be set so that precipitates in the slits 12 are pushed and flushed out by using an additional blower.

It is also possible to use the aeration apparatus 120B shown in FIG. 5 that includes the water supply line L₆ for supplying the fresh water 141 to the air supply line L₅, and cause the control unit (not shown) to perform control for temporarily increasing the supply of the air 122 and simultaneously feeding the fresh water 141 to the air supply line L₅.

Aeration nozzles according to the present embodiment will next be described. The present invention provides aeration nozzles that cause precipitates deposited in the diffuser membranes 11 to come off easily.

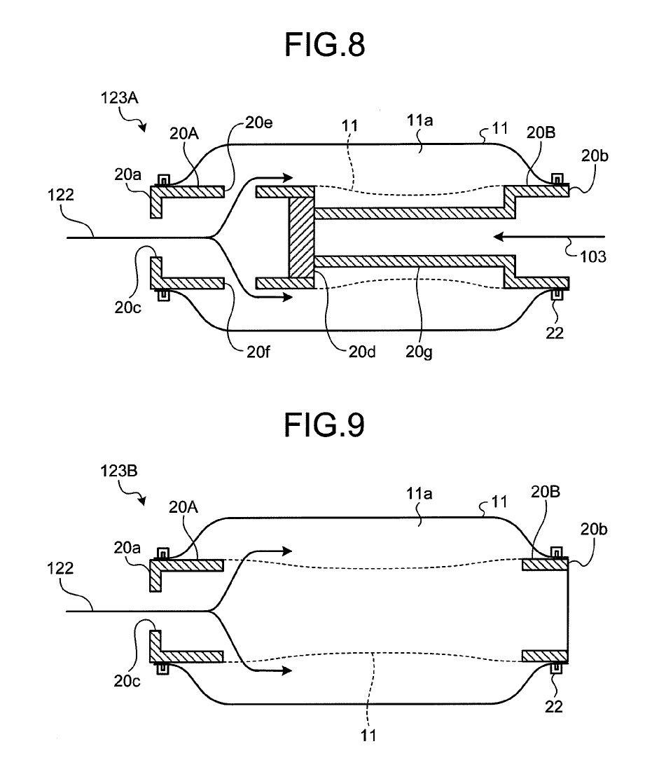

FIG. 8 is a schematic diagram of the inner structure of an aeration nozzle 123A according to the present embodiment.

As shown in FIG. 8, the aeration nozzle 123A according to the present embodiment includes: a cylindrical base support body 20A into which air is introduced; a hollow cylindrical body 20g that has a diameter smaller than the diameter of the base support body 20A and that is disposed at axial position via a partition plate 20d; an end support body 20B that is disposed at one end of the hollow cylindrical body 20g and that has approximately the same diameter as the diameter of the base support body 20A; a tubular diffuser membrane 11 that covers the base support body 20A and the end support body 20B and of which both ends are fastened to the base support body and the end support body, respectively, with fastening members 22; a large number of slits (not shown) formed in the diffuser membrane 11; and air outlet holes 20e and 20f formed in the side surface of the base support body 20A for allowing the introduced air 122 to flow into the pressurization space 11a between the inner circumferential surface of the diffuser membrane 11 and the outer circumferential surfaces of the support bodies in front of the partition plate 20d. Therefore, as indicated by arrows in the figure, the air 122 flowing from the header to the aeration nozzle 123A first flows into the base support body 20A through the air inlet port 20c and then flows into the pressurization space 11a through the air outlet holes 20e and 20f.

When the supply of the air 122 is stopped, as indicated by a dashed line in FIG. 8, the diffuser membrane 11 is contracted and portions corresponding to portions of the hollow cylindrical body 20g with a small diameter are deformed. Therefore, the slits 12 of the diffuser membrane 11 are deformed, which help precipitates to come off.

FIG. 9 is a schematic diagram of the inner structure of another aeration nozzle 123B according to the present embodiment. The aeration nozzle 123B according to the present embodiment includes: a cylindrical base support body 20A into which air is introduced; an end support body 20B that has approximately the same diameter as the diameter of the base support body 20A; a tubular diffuser membrane 11 that covers the base support body 20A and the end support body 20B and of which both ends are fastened to the base support body and the end support body, respectively, with the fastening members 22; and a large number of slits 12 formed in the diffuser membrane 11.

While the aeration nozzle 123 shown in FIG. 3 is structured such that the diffuser membrane 11 covers the support body 20, the diffuser membrane 11 of the aeration nozzle 123B shown in FIG. 9 stands by itself and is supported by the end support body 20B only at the tips. Therefore, the diffuser membrane 11 expands while the air 122 is being supplied, and is contracted and deformed as indicated by a dashed line when the supply of the air 122 is stopped. Accordingly, precipitates adhered to the slits easily come off.

The precipitates that have come off are accumulated inside the diffuser membrane 11. Therefore, it is not necessary to form slits at portions where the precipitates are accumulated. When forming slits, it is preferable to form extra slits in advance by taking into account clogging of slits that may occur, so that the supply amount of air is not reduced even when precipitates that have come off are accumulated in the slits.

In addition to the tube-type aeration nozzle, a disk-type aeration nozzle will be described.

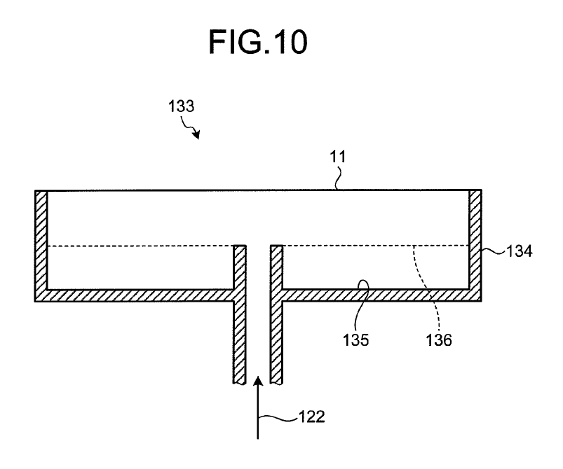

FIG. 10 is a schematic diagram of a disk-type aeration nozzle according to the present embodiment. As shown in FIG. 10, a disk-type aeration nozzle 133 includes a precipitate housing unit 135 at the bottom portion of a cylindrical support body 134 of the diffuser membrane 11. A partition such as punching metal 136 is disposed in the housing unit 135 so as not to block flow of introduced air 122. Because precipitates are caused to fall down under the punching metal 136, they are not blown upward even when the air 122 is supplied.

In the description in the present embodiment, seawater is exemplified as water to be treated, but the invention is not limited thereto. For example, in an aeration apparatus for aerating polluted water in polluted water treatment, plugging caused by deposition of sludge components on diffuser slits (membrane slits) can be prevented, and the aeration apparatus can be stably operated for a long time.

In the present embodiment, tube-type aeration nozzles are used in the aeration apparatuses, but the present invention is not limited thereto. For example, the invention is applicable to disk-type and flat-type aeration apparatuses having diffuser membranes and to diffusers including ceramic or metal diffuser membranes having slits that are open at all times.

### INDUSTRIAL APPLICABILITY

As described above, in the aeration apparatus according to the present invention, precipitates generated in the slits of the diffuser membranes of the aeration apparatus can be removed. For example, when applied to a seawater flue gas desulphurization apparatus, the aeration apparatus can be continuously operated in a stable manner for a long time.

### REFERENCE SIGNS LIST

11 diffuser membrane

12 slit

100 seawater flue gas desulphurization apparatus

102 flue gas desulphurization absorber

103 seawater

103A used seawater

103B diluted used seawater

105 dilution-mixing basin

106 oxidation basin

120A, 120B aeration apparatus

123 aeration nozzle

1. An aeration apparatus that is immersed in water to be treated and generates fine air bubbles in the water to be treated, the aeration apparatus comprising:
an air supply pipe for supplying air through discharge unit;
an aeration nozzle including a diffuser membrane having a slit, the air being supplied to the aeration nozzle; and
a control unit for performing control to temporarily stop supply of the air at predetermined intervals.

2. An aeration apparatus that is immersed in water to be treated and generates fine air bubbles in the water to be treated, the aeration apparatus comprising:
an air supply pipe for supplying air through discharge unit;
an aeration nozzle including a diffuser membrane having a slit, the air being supplied to the aeration nozzle; and
a control unit for performing control to temporarily increase supply of the air at predetermined intervals.

3. The aeration apparatus according to claim 2, wherein
the control unit performs control to temporarily increase the supply of the air and simultaneously feed water to the air supply pipe.

4. The aeration apparatus according to claim 1, wherein
the control unit performs control to temporarily stop the supply of the air and simultaneously feed water to the air supply pipe.

5. The aeration apparatus according to claim 1, wherein
the aeration nozzle further includes:
a cylindrical base support body into which the air is introduced;
a hollow cylindrical body that has a diameter smaller than a diameter of the base support body and that is disposed at an axial position of the base support body via a partition plate;
an end support body that is disposed at one end of the hollow cylindrical body and that has approximately the same diameter as the diameter of the base support body;
a tubular diffuser membrane that covers the base support body and the end support body and of which both ends are fastened to the base support body and the end support body, respectively;
a large number of the slits formed in the tubular diffuser membrane; and
an air outlet hole formed in the side surface of the base support body for allowing introduced air to flow into a pressurization space between an inner circumferential surface of the diffuser membrane and outer circumferential surfaces of the support bodies in front of the partition plate.

6. The aeration apparatus according to claim 1, wherein
the aeration nozzle further includes
a cylindrical base support body into which the air is introduced;
an end support body that has approximately the same diameter as the base support body;
a tubular diffuser membrane that covers the base support body and the end support body and of which both ends are fastened to the base support body and the end support body, respectively; and
a large number of the slits formed in the tubular diffuser membrane.

7. A seawater flue gas desulphurization apparatus, comprising:
a desulfurizer that uses seawater as an absorbent;
a water passage for allowing used seawater discharged from the desulfurizer to flow therethrough and be discharged; and
the aeration apparatus according to claim 1 that is disposed in the water passage, the aeration apparatus generating fine air bubbles in the used seawater to decarbonate the used seawater.

8. A method for operating an aeration apparatus, the method comprising:
using an aeration apparatus that is immersed in water to be treated and used to generate fine air bubbles in the water to be treated; and
temporarily stopping or increasing supply of air at predetermined intervals when supplying air through discharge unit, thereby preventing clogging.

9. The method according to claim 8, further comprising:
feeding water to an air supply pipe, the feeding being performed independently or at the same time when temporarily stopping or increasing the supply of air.
